(19) United States
(12) Patent Application Publication
(10) Pub. No.: US 2011/0271616 A1
(43) Pub. Date: Nov. 10, 2011

(54) NATURALLY SOURCED BUILDING MATERIALS

(75) Inventors: Robert R. Rasmussen, Lansing, NY (US); Patrick J. Govang, Ithaca, NY (US); Clayton D. Poppe, Ithaca, NY (US); Thomas P. G. Schryver, Ithaca, NY (US); William Pinkham, Owego, NY (US)

(73) Assignee: E2E MATERIALS, Ithaca, NY (US)

(21) Appl. No.: 13/086,527

(22) Filed: Apr. 14, 2011

Related U.S. Application Data
(60) Provisional application No. 61/325,049, filed on Apr. 16, 2010.

(51) Int. Cl. E04C 2/20; B32B 3/00; C08K 11/00; E04C 2/52; C08K 5/1545; C08K 5/00

(52) U.S. Cl. 52/220.1; 524/27; 523/122; 524/12; 524/15; 524/13; 524/34; 52/309.1; 428/220; 428/156

(57) ABSTRACT

The present invention provides environmentally friendly compositions, resins comprising the same, and composites thereof.

### CROSS-REFERENCE TO RELATED APPLICATIONS

The present application claims priority to U.S. provisional application Ser. No. 61/325,049, filed Apr. 16, 2010, the entirety of which is incorporated herein by reference.

### FIELD OF THE INVENTION

The present invention relates to protein-based polymeric compositions and, more particularly, to building materials comprising environmentally friendly polymeric compositions containing protein in combination with green strengthening agents.

### BACKGROUND OF THE INVENTION

Concerns about the environment, both with respect to pollution and sustainability, are rapidly rising. Most commercially available composites such as oriented strand board and particle board used today are made using petroleum based composites. Petroleum-based composites are composed of fibers, such as glass, graphite, aramid, etc., and resins, such as epoxies, polyimides, vinylesters, nylons, polypropylene, etc. Petroleum- or formaldehyde-based resins are inexpensive, colorless, and are able to cure fast to form a rigid polymer. However, the use of petroleum-based composites negatively affects the environment.

Of particular concern is the rate at which petroleum-based composites degrade under the anaerobic conditions present in landfills, potentially persisting without appreciable degradation for decades if not centuries, rendering the land unusable. In addition, since composites are made using two dissimilar materials, they cannot be easily recycled or reused. This is particularly true for thermoset resins. While the composites may be incinerated to obtain heat value, the toxic gases produced must be treated using expensive scrubbers. As a result, at the end of their life, most composites end up in land-fills. With applications multiplying in the past few years and expected to increase further, composite waste disposal is a serious concern.

Most significantly, wood products containing petroleum-based resins slowly emit formaldehyde and other Volatile Organic Compounds (VOCs) into the surrounding environment. Because formaldehyde resins are used in many construction materials it is one of the more common indoor air pollutants. Recent legislation has prohibited or severely restricted the use of formaldehyde in one or more states.

Notwithstanding the environmental impact of disposing of petroleum-based composites, petroleum is not a replenishable commodity and is consumed at an unsustainable rate. As the supply of petroleum dwindles, its price will rise at an ever increasing rate, thereby increasing the price of petroleum-based products.

The use of renewable materials from sustainable sources is increasing in a variety of applications. Biocomposites are materials that can be made in nature or produced synthetically, and include some type of naturally occurring material such as natural fibers in their structure. They may be formed through the combination of natural cellulose fibers with other resources such as biopolymers, resins, or binders based on renewable raw materials. Biocomposites can be used for a range of applications, for example: building materials, structural and automotive parts, absorbents, adhesives, bonding agents and degradable polymers. The increasing use of these materials serves to maintain a balance between ecology and economy. The properties of plant fibers can be modified through physical and chemical technologies to improve performance of the final biocomposite. Plant fibers with suitable properties for making biocomposites include, for example, hemp, kenaf, jute, flax, sisal, banana, pineapple, sugar cane bagasse, corn stover, straw, ramie and kapok.

Biopolymers derived from various natural botanical resources such as protein and starch have been regarded as alternative materials to petroleum plastics because they are abundant, renewable and inexpensive. The widespread domestic cultivation of soybeans has led to a great deal of research into the development of biopolymers derived from their byproducts. Soy protein is an important alternative to petroleum based materials because it is abundant, renewable and inexpensive. Soy proteins, which are complex macromolecular polypeptides containing 20 different amino acids, can be converted into environmentally friendly plastics. However, soy protein plastics suffer the disadvantages of low strength and high moisture absorption.

Accordingly, due to environmental, health, and regulatory issues related to formaldehyde emissions from wood products, there exists a need to create a petroleum-free resin or composite system that is environmentally friendly and meets or exceeds the strength of particle board.

### DETAILED DESCRIPTION OF THE INVENTION

In certain embodiments, the present invention provides a building material comprising a biocomposite. In some embodiments, the biocomposite comprises a resin comprising an environmentally friendly polymeric composition. In some embodiments, a provided resin comprises a protein and a first strengthening agent. Such environmentally friendly polymeric compositions, strengthening agents, resins, and composites are described in detail herein, infra.

### Definitions

The term “environmentally friendly” is used herein to mean a product or substance which does not contain petroleum-based reagents or products. In some embodiments, the term “environmentally friendly” is used herein to mean a product or substance which does not emit volatile organic compounds into the environment. In some embodiments, volatile organic compounds include formaldehyde. Alternatively or additionally, the term “environmentally friendly” is used herein to mean a product or substance which is biodegradable.

The term “strengthening agent” is used herein to describe a material whose inclusion in the environmentally friendly polymeric composition of the present invention results in an improvement in any of the characteristics “stress at maximum load”, “fracture stress”, “fracture strain”, “modulus”, and “toughness” measured for a solid article formed by curing of the composition, compared with the corresponding characteristic measured for a cured solid article obtained from a similar composition lacking the strengthening agent.

The term “curing” is used herein to describe subjecting the composition of the present invention to conditions of temperature and pressure effective to form a solid article.

The term “array” is used herein to mean a network structure.

The term “mat” is used herein to mean a collection of raw fibers joined together.

The term “prepreg” is used herein to mean a fiber structure that has been impregnated with a resin prior to curing the composition.

In some aspects, the present invention provides a resin comprising an environmentally friendly polymeric composition. In some embodiments, a resin comprises a protein and a first strengthening agent. In other embodiments, a provided resin further optionally comprises a plasticizer, an antimicrobial agent and/or an antimoisture agent. In some embodiments, a provided resin is an aqueous resin. In other embodiments, a provided resin is a dry resin (i.e., a provided resin in dry form, such as in the form of a powder, flakes, granules, spheroids, etc.). Such resin is made entirely of environmentally friendly materials. In some embodiments, a provided resin is made from a renewable source including a yearly renewable source. In some embodiments, no ingredient of the resin is toxic to the human body (i.e., general irritants, toxins or carcinogens). In certain embodiments, a provided resin does not include formaldehyde or urea derived materials.

### Suitable Protein

As generally described above, a provided environmentally friendly polymeric composition comprises a protein.

Suitable protein for use in a provided composition typically contains about 20 different amino acids, including those that contain reactive groups such as —COOH, —NH₂ and —OH groups. Once processed, protein itself can form crosslinks through the —SH groups present in the amino acid cysteine as well as through the dehydroalanine (DHA) residues formed from alanine by the loss of the α-hydrogen and one of the hydrogens on the methyl group side chain, forming an α,β-unsaturated amino acid. DHA is capable of reacting with lysine and cysteine by forming lysinoalanine and lanthionine crosslinks, respectively. Asparagines and lysine can also react together to form amide type linkages. All these reactions can occur at higher temperatures and under pressure that is employed during curing of the protein. However, the crosslinked protein is very brittle and has low strength.

Without wishing to be bound by a particular theory, it is believed that the protein concentration of a given protein source is directly proportional to the extent of crosslinking (the greater the protein concentration the greater crosslinking of the resin). Greater crosslinking in the resin produces composites with more rigidity and strength. Altering the ratio of protein to plasticizer allows those skilled in the art to select and fine tune the rigidity of the resulting composites.

In addition to the self-crosslinking capability of protein, the reactive groups can be utilized to modify the proteins further to obtain desired mechanical and physical properties. The most common protein modifications include: addition of crosslinking agents and internal plasticizers, blending with other resins, and forming interpenetrating networks (IPN) with other crosslinked systems. These modifications are intended to improve the mechanical and physical properties of the resin. The properties of the resins can be further improved by adding nanoclay particles and micro- and nano-fibrillated cellulose (MFC, NFC), as described in, for example, Huang, X. and Netravali, A. N., “Characterization of flax yarn and flax fabric reinforced nano-clay modified soy protein resin composites,” Compos. Sci. and Technol. 2007, 67, 2005; and Netravali, A. N.; Huang, X.; and Mizuta, K., “Advanced Green Composites,” Advanced Composite Materials 2007, 16, 269.

In some embodiments, a protein is a plant-based protein. In some embodiments, a provided plant-based protein is obtained from a seed, stalk, fruit, root, husk, stover, leaf, stem, bulb, flower or algae, either naturally occurring or bioengineered. In some embodiments, the plant-based protein is soy protein.

Soy Protein. Soy protein has been modified in various ways and used as resin in the past, as described in, for example, Netravali, A. N. and Chabba, S., Materials Today, pp. 22-29, April 2003; Lodha, P. and Netravali, A. N., Indus. Crops and Prod. 2005, 21, 49; Chabba, S. and Netravali, A. N., J. Mater. Sci. 2005, 40, 6263; Chabba, S. and Netravali, A. N., J. Mater. Sci. 2005, 40, 6275; and Huang, X. and Netravali, A. N., Biomacromolecules, 2006, 7, 2783.

Soy protein useful in the present invention includes soy protein from commercially available soy protein sources. The protein content of the soy protein source is proportional to the resulting strength and rigidity of the composite boards because there is a concomitant increase in the crosslinking of the resin. In some embodiments, the soy protein source is treated to remove any carbohydrates, thereby increasing the protein levels of the soy source. In other embodiments, the soy protein source is not treated.

In some embodiments, the concentration of the soy protein in the soy protein source is about 90-95%. In other embodiments, the concentration of the soy protein in the soy protein source is about 70-89%. In still other embodiments, the concentration of the soy protein in the soy protein source is about 60-69%. In still other embodiments, the concentration of the soy protein in the soy protein source is about 45-59%.

In some embodiments, the soy protein source is soy protein isolate.

In some embodiments, the soy protein source is soy protein concentrate. In some embodiments, the soy protein concentrate is commercially available, for example, Arcon S® or Arcon F®, which may be obtained from Archer Daniels Midland.

In some embodiments, the soy protein source is soy flour. In certain embodiments, the soy flour is ADM 7B and Cargill 100-90.

Alternative Proteins. As described above, suitable protein for use in the present invention includes plant-based protein. In certain embodiments, the plant-based protein is other than a soy-based protein. In some embodiments, a provided plant-based protein is obtained from a seed, stalk, fruit, root, husk, stover, leaf, stem, algae, bulb or flower, either naturally occurring or bioengineered. In some embodiments, the plant-based protein obtained from seed is a canola or sunflower protein. In other embodiments, the plant-based protein obtained from grain is rye, wheat or corn protein. In still other embodiments, a plant-based protein is isolated from protein-producing algae.

In some embodiments, a protein suitable for use in the present invention includes animal-based protein, such as collagen, gelatin, casein, albumin, silk and elastin.

In some embodiments, a protein for use in the present invention includes protein produced by microorganisms. In some embodiments, such microorganisms include algae, bacteria and fungi, such as yeast.

In still other embodiments, a protein for use in the present invention includes biodiesel byproducts.

### Strengthening Agent

As described generally above, a provided resin includes a first strengthening agent. In one embodiment, the strengthening agent is a green polysaccharide. In another embodiment, the strengthening agent is a carboxylic acid. In yet another embodiment, the strengthening agent is a nanoclay. In yet another embodiment, the strengthening agent is a microfibrillated cellulose or nanofibrillated cellulose. In some embodiments, the weight ratio of protein to first strengthening agent in the environmentally friendly polymeric composition of the present invention is about 20:1 to about 1:1. In some embodiments, the weight ratio of soy protein to first strengthening agent in the biodegradable polymeric composition of the present invention is about 50:1 to about 1:1.

Green Polysaccharides. In one embodiment, the first strengthening agent is a green polysaccharide. In one embodiment, the strengthening agent is soluble (i.e., substantially soluble in water at a pH of about 7.0 or higher). In some embodiments, the green polysaccharide is a carboxy-containing polysaccharide. In another embodiment, the green polysaccharide is agar, gellan, agaropectin or a mixture thereof.

Gellan gum is commercially available as Phytagel™ from Sigma-Aldrich Biotechnology. It is produced by bacterial fermentation and is composed of glucuronic acid, rhanmose and glucose, and is commonly used as a gelling agent for electrophoresis. Based on its chemistry, cured Phytagel™ is fully degradable. Gellan, a linear tetrasaccharide that contains glucuronic acid, glucose and rhamnose units, is known to form gels through ionic crosslinks at its glucuronic acid sites using divalent cations naturally present in most plant tissue and culture media. In the absence of divalent cations, higher concentration of gellan is also known to form strong gels via hydrogen bonding.

The mixing of gellan with soy protein isolate has been shown to result in improved mechanical properties. See, for example, Huang, X. and Netravali, A. N., Biomacromolecules, 2006, 7, 2783 and Lodha, P. and Netravali, A. N., Polymer Composites, 2005, 26, 647. During curing, crosslinking occurs in both the protein and in the polysaccharide, individually to form arrays of cured protein and arrays of polysaccharide. Intermingling occurs because the two arrays are mixed together. Hydrogen bonding occurs between the formed arrays of cured protein and cured polysaccharide because both arrays contain polar groups such as —COOH and —OH groups, and in the case of protein, —NH₂ groups.

In other embodiments, the green polysaccharide is selected from the group comprising carageenan, agar, gellan, agarose, alginic acid, ammonium alginate, annacardium occidentale gum, calcium alginate, carboxyl methyl-cellulose (CMC), carubin, chitosan acetate, chitosan lactate, E407a processed eucheuma seaweed, gelrite, guar gum, guaran, hydroxypropyl methylcellulose (HPMC), isabgol, locust bean gum, pectin, pluronic polyol F127, polyoses, potassium alginate, pullulan, sodium alginate, sodium carmellose, tragacanth, xanthan gum, galactans, agaropectin and mixtures thereof. In some embodiments, the polysaccharide may be extracted from seaweed and other aquatic plants. In some embodiments, the polysaccharide is agar agar.

Carboxylic acids and esters. In some embodiments, the first strengthening agent is a carboxylic acid or ester. One of ordinary skill in the art will appreciate that strengthening agents containing carboxylic acids or esters can crosslink with suitable groups on a protein (e.g., via amino groups present on the protein). In some embodiments, the carboxylic acid or ester strengthening agent is selected from the group comprising caproic acids, caproic esters, castor bean oil, fish oil, lactic acids, lactic esters, poly L-lactic acid (PLLA) and polyols.

Other Polymers. In still other embodiments, the first strengthening agent is a polymer. In some embodiments, the polymer is a biopolymer. In one embodiment, the first strengthening agent is a polymer such as lignin. In other embodiments, the biopolymer is gelatin or another suitable protein gel.

Nanoclay. In some embodiments, the first strengthening agent is a clay. In other embodiments, the clay is a nanoclay. In some embodiments, a nanoclay has a dry particle size of 90% less than 15 microns. The composition can be characterized as green since the nanoclay particles are natural and simply become soil particles if disposed of or composted. The nanoclay does not take part in the crosslinking but is rather present as a reinforcing additive and filler. As used herein, the term “nanoclay” means clay having nanometer thickness silicate platelets. In some embodiments, a nanoclay is a natural clay such as montmorillonite. In other embodiments, a nanoclay is selected from the group comprising fluorohectorite, laponite, bentonite, beidellite, hectorite, saponite, nontronite, sauconite, vermiculite, ledikite, nagadiite, kenyaite and stevensite.

Cellulose. In some embodiments, the first strengthening agent is a cellulose. In some embodiments, a cellulose is a microfibrillated cellulose (MFC) or nanofibrillated cellulose (NFC). MFC is manufactured by separating (shearing) the cellulose fibrils from several different plant varieties. Further purification and shearing, produces nanofibrillated cellulose. The only difference between MFC and NFC is size (micrometer versus nanometer). The compositions are green because the MFC and NFC degrade in compost medium and in moist environments through microbial activity. Up to 60% MFC or NFC by weight ((uncured protein plus green strengthening agent basis) improves the mechanical properties of the composition significantly. The MFC and NFC do not take part in any crosslinking but rather are present as strengthening additives or filler. However they are essentially uniformly dispersed in the environmentally friendly composition and, because of their size and aspect ratio, act as reinforcement.

Other Strengthening Agents. It will be appreciated by those skilled in the art that any cross-linking agent may be used as a strengthening agent in the present invention. For example, in some embodiments, a strengthening agent is a cross-linking agent such as azetidinium resins, polyamide-epichlorohydrin resins, epoxide resins, polyacrylamide-glyoxal resins, carbodiimides, hydroxysuccinamide esters or hydrazide. In other embodiments, a strengthening agent is an aldehyde, such as formaldehyde or acetaldehyde, or dialdehyde, such as glutaraldehyde or glyoxal. In still other embodiments, a strengthening agent is a polyphosphate such as sodium pyrophosphate.

It will be appreciated by those skilled in the art that a resin of the present invention also includes resins containing various combinations of strengthening agents. For example only, in one embodiment the resin composition comprises a protein from 98% to 20% by weight protein (uncured protein plus first strengthening agent basis) and from 2% to 80% by weight of first strengthening agent (uncured protein plus first strengthening agent basis) wherein the first strengthening agent consists of from 1% to 65% by weight cured green polysaccharide and from 0.1% to 15% by weight nanoclay (uncured protein plus nanoclay plus polysaccharide basis).

In another embodiment, the resin composition comprises a protein from 98% to 20% by weight protein (uncured protein plus first strengthening agent basis) and from 2% to 80% by weight of first strengthening agent (uncured protein plus first strengthening agent basis) wherein the first strengthening agent consists of from 1% to 79% by weight cured green polysaccharide and from 0.1% to 79% by weight microfibrillated or nanofibrillated cellulose (uncured protein plus polysaccharide plus MFC or NFC basis).

### Plasticizer

As described above, the resin containing a protein and a first strengthening agent optionally further comprises a plasticizer. Without wishing to be bound by any particular theory, it is believed that the addition of a plasticizer reduces the brittleness of the crosslinked protein, thereby increasing the strength and rigidity of the composite. In some embodiments, the weight ratio of plasticizer: (protein+first strengthening agent) is about 1:20 to about 1:4. In some embodiments, the ratio of protein to plasticizer is 4:1. Suitable plasticizers for use in the present invention include a hydrophilic or hydrophobic polyol. In some embodiments, a provided polyol is a C₁₋₃ polyol. In one embodiment, the C₁₋₃ polyol is glycerol. In other embodiments, a provided polyol is a C₄₋₇ polyol. In one embodiment, the C₄₋₇ polyol is sorbitol. In some embodiments, the C₄₋₇ polyol is selected from propylene glycol, diethylene glycol and polyethylene glycols in the molecular weight range of 200-400 atomic mass units.

In certain embodiments, a polyol plasticizer is a polyphosphate such as sodium pyrophosphate.

In still other embodiments, a plasticizer is selected from the group comprising environmentally safe phthalates diisononyl phthalate (DINP) and diisodecyl phthalate (DIDP), food additives such as acetylated monoglycerides alkyl citrates, triethyl citrate (TEC), acetyl triethyl citrate (ATEC), tributyl citrate (TBC), acetyl tributyl citrate (ATBC), trioctyl citrate (TOC), acetyl trioctyl citrate (ATOC), trihexyl citrate (THC), acetyl trihexyl citrate (ATHC), butyryl trihexyl citrate (BTHC), trimethyl citrate (TMC), alkyl sulfonic acid phenyl ester (ASE), lignosulfonates, beeswax, oils, sugars, polyols such as sorbitol and glycerol, low molecular weight polysaccharides or a combination thereof.

### Antimoisture Agent

A provided resin optionally further comprises an antimoisture agent which inhibits moisture absorption by the composite. The antimoisture agent may also optionally decrease any odors that result from the use of proteins. In some embodiments, an antimoisture agent is a wax or an oil. In other embodiments, an antimoisture agent is a plant-based wax or plant-based oil. In still other embodiments, an antimoisture agent is a petroleum-based wax or petroleum-based oil. In yet other embodiments, an antimoisture agent is an animal-based wax or animal-based oil.

In some embodiments, a plant-based antimoisture agent is selected from the group comprising carnauba wax, tea tree oil, soy wax, soy oil, lanolin, palm oil, palm wax, peanut oil, sunflower oil, rapeseed oil, canola oil, algae oil, coconut oil and carnauba oil.

In some embodiments, a petroleum-based antimoisture agent is selected from the group comprising paraffin wax, paraffin oil and mineral oil.

In some embodiments, an animal-based antimoisture agent is selected from the group comprising beeswax and whale oil.

In some embodiments, an antimoisture agent is a lignin. In some embodiments, an antimoisture agent is a lignosulfonate. In still other embodiments, an antimoisture agent is stearic acid. In other embodiments, an antimoisture agent is a salt of stearic acid, such as sodium stearate, calcium stearate. In some embodiments, an antimoisture agent is a stearate ester such as polyethylene glycol stearate, methyl-, ethyl-, propyl, butyl-stearate, and the like, octyl-stearate, isopropyl stearate, myristyl stearate, ethylhexyl stearate, cetyl stearate and isocetyl stearate.

In some embodiments, an antimoisture agent is a cross-linking agent such as azetidinium resins, polyamide-epichlorohydrin resins, epoxide resins, polyacrylamide-glyoxal resins, carbodiimides, hydroxysuccinamide esters or hydrazide. In other embodiments, an antimoisture agent is an aldehyde or dialdehyde, such as glutaraldehyde or glyoxal. In still other embodiments, an antimoisture agent is a polyphosphate such as sodium pyrophosphate. In some embodiments, an antimoisture agent is a polyethylene or polypropylene emulsion. In certain embodiments, an antimoisture agent is an ethylene-acrylic acid copolymer.

It will be appreciated by those skilled in the art that, in some embodiments, one additive in the present invention may serve a dual purpose. For example, as described above, in some embodiments, a cross-linking agent such as a carbodiimide, hydroxysuccinamide ester or hydrazide is both a first strengthening agent and an antimoisture agent. In other embodiments, a polyol such as polyproplyene glycol, diethylene glycol or polyphosphate is both a plasticizer and an antimoisture agent. Those skilled in the art can readily identify which agents serve more than one purpose.

### Antimicrobial Agent

In accordance with the present invention, the protein resin may optionally contain an antimicrobial agent. In some embodiments, an antimicrobial agent is an environmentally safe agent. In some embodiments, an antimicrobial agent is a guanidine polymer. In some embodiments, the guanidine polymer is Teflex®. In other embodiments, an antimicrobial agent is selected from the group comprising tea tree oil, parabens, paraben salts, quaternary ammonium salts such as n-alkyl dimethylbenzyl ammonium chloride or didecyldimethyl ammonium chloride, allylamines, echinocandins, polyene antimycotics, azoles, isothiazolinones, imidazolium, sodium silicates, sodium carbonate, sodium bicarbonate, potassium iodide, silver, copper, sulfur, grapefruit seed extract, lemon myrtle, olive leaf extract, patchouli, citronella oil, orange oil, pau d'arco and neem oil. In some embodiments, the parabens are selected from the group comprising methyl, ethyl, butyl, isobutyl, isopropyl and benzyl paraben and salts thereof. In some embodiments, the azoles are selected from the group comprising imidazoles, triazoles, thiazoles and benzimidazoles.

In some embodiments, an antimicrobial agent is boric acid, or an acceptable salt thereof. In some embodiments, an antimicrobial agent is a boric acid salt, such as sodium borate, sodium tetraborate, disodium tetraborate, potassium borate, potassium tetraborate, and the like.

In some embodiments, an antimicrobial agent is Microban™.

In some embodiments, an antimicrobial agent is a pyrithione salt such as zinc pyrithione, sodium pyrithione, etc.

### Composites

In some embodiments, a provided resin is useful for combination with green reinforcing materials to form a composite.

### Fiber

In some embodiments, the present invention provides a composite comprising an environmentally friendly polymeric composition, as described herein. In certain embodiments, a provided composite is comprised of a protein, a first strengthening agent and an optional second strengthening agent of natural origin that can be a particulate material, a fiber, or a combination thereof. More precisely, the second strengthening agent of natural origin includes green reinforcing fiber, filament, yarn, and parallel arrays thereof, woven fabric, knitted fabric and/or non-woven fabric of green polymer different from the protein, or a combination thereof.

In some embodiments, a second strengthening agent is a woven or non-woven, scoured or unscoured natural fiber. In some embodiments, a natural scoured, non-woven fiber is cellulose-based fiber. In other embodiments, a natural scoured, non-woven fiber is animal-based fiber.

In some embodiments, a cellulose-based fiber is fiber obtained from a commercial supplier and available in a variety of packages, for example loose, baled, bagged, or boxed fiber. In other embodiments, the cellulose-based fiber, is selected from the group comprising kenaf, hemp, flax, wool, silk, cotton, ramie, sorghum, raffia, sisal, jute, sugar cane bagasse, coconut, pineapple, abaca (banana), sunflower stalk, sunflower hull, peanut hull, wheat straw, oat straw, hula grass, henequin, corn stover, bamboo and saw dust. In other embodiments, a cellulose-based fiber is a recycled fiber from clothing, wood and paper products. In still other embodiments, the cellulose-based fiber is manure. In yet other embodiments, the cellulose-based fiber is regenerated cellulose fiber such as viscose rayon and lyocell.

In some embodiments, an animal-based fiber includes hair or fur, silk, fiber from feathers from a variety of fowl including chicken and turkey, and regenerated varieties such as spider silk and wool.

In some embodiments, a non-woven fiber may be formed into a non-woven mat.

In some embodiments, a non-woven fiber is obtained from the supplier already scoured. In other embodiments, a non-woven fiber is scoured to remove the natural lignins and pectins which coat the fiber. In still other embodiments, a non-woven fiber is used without scouring.

In yet other embodiments, a fiber for use in the present invention is scoured or unscoured, woven fabric. In some embodiments, a woven fabric is selected from the group comprising burlap, linen or flax, wool, cotton, hemp, silk and rayon. In some embodiments, the woven fabric is burlap. In another embodiment, the woven fabric is a dyed burlap fabric. In still another embodiment, the woven fabric is an unscoured burlap fabric.

In still other embodiments, a fiber for use in the present invention is a combination of non-woven fiber and woven fabric.

In some embodiments, a fiber for use in the present invention is colored with pigments and/or dyes prior to being impregnated with resin. In some embodiments, the resin is colored with pigments and/or dyes prior to impregnating the fiber structure. In some embodiments, colored fibers are applied to one or more surfaces of the prepreg prior to the pressing step. In some embodiments, a prepreg is colored with pigments and/or dyes prior to pressing.

In some embodiments, the woven fabric is combined with a provided resin comprising a protein and a first strengthening agent and pressed into a composite as described herein, infra.

In certain embodiments, the composite is comprised of a provided resin comprising a protein, a first strengthening agent and optionally a second strengthening agent, wherein the second strengthening agent is impregnated with an aqueous resin to form a mat known as a prepreg. The prepreg is then subjected to conditions of temperature and/or pressure sufficient to form a composite. Two or more prepregs may be optionally stacked to achieve a desired thickness. Optionally, the prepregs are stacked or interlayered with one or more optionally impregnated woven fabrics, resulting in a stronger and more durable composite. In some embodiments, the prepregs are interlayered with optionally impregnated woven burlap. In some embodiments, the outer surfaces of the stack of prepregs are covered with decorative or aesthetic layers such as fabrics or veneers. In some embodiments, the fabrics are silkscreened to produce a customized composite. Significantly, the present invention further provides for a one-step process for pressing and veneering a composite without the use of a formaldehyde-based adhesive, as the resin itself crosslinks the prepregs with the veneer, resulting in an environmentally friendly veneered composite. In other embodiments, the veneer is adhered to the composite with a suitable adhesive, for example wood glue.

Alternatively, the composite is comprised of a dry resin comprising a protein, a first strengthening agent and optionally a second strengthening agent, wherein the second strengthening agent is combined with the dry resin to form a resin/mat complex, which may be optionally moistened with a wetting agent before being subjected to conditions of temperature, humidity, and/or pressure sufficient to form a composite. Two or more resin/mat complexes may be optionally stacked to achieve a desired thickness.

In some embodiments, the second strengthening agent is pretensioned prior to being impregnated and/or cured.

Optionally, the resin/mat complexes are stacked or interlayered with one or more optionally impregnated woven fabrics, resulting in a stronger and more durable composite. In some embodiments, the resin/mat complexes are interlayered with optionally impregnated woven burlap. In some embodiments, the outer surfaces of the stack of resin/mat complexes are covered with decorative or aesthetic layers such as fabrics or veneers. In some embodiments, the fabrics are silkscreened to produce a customized composite. Significantly, the present invention further provides for a one-step process for pressing and veneering a composite without the use of a formaldehyde-based adhesive, as the resin itself crosslinks the prepregs with the veneer, resulting in an environmentally friendly veneered composite. In other embodiments, the veneer is adhered to the composite with a suitable adhesive, for example wood glue.

In some embodiments, the stacked prepregs or resin/mat complexes can be pressed directly into a mold, thereby resulting in a contoured composite. In a further embodiment, the prepreg or resin/mat complex can be both veneered and molded in a single step. Wood for a veneer ply includes but is not limited to any hardwood, softwood or bamboo. In some embodiments, the veneer is bamboo, pine, white maple, red maple, poplar, walnut, oak, redwood, birch, mahogany, ebony and cherry wood.

In some embodiments, the composites can contain variable densities throughout a single board. In some embodiments, composites of the present invention contain at least one contoured surface. In some embodiments, composites of the present invention contain two contoured surfaces. In some embodiments, the variable density is created by a mold which is contoured on one surface but flat on the other, thereby applying variable pressure to the contoured surface. In other embodiments, the variable density is created by building up uneven layers of prepregs or resin/mat complexes, where the more heavily layered areas result in the more dense sections of the composite boards.

In some embodiments, the pressing of the prepregs or resin/mat complexes contains a tooling step, which may occur before or after the pressing or curing step but prior to or after the release of the composite from the mold. In some embodiments, the tooling step occurs after the prepregs or resin/mat complexes are loaded into the mold but prior to the pressing or curing step. Such step comprises subjecting the mold containing the prepregs or resin/mat complexes to a tooling apparatus which trims the outer edges of the prepreg or resin/mat complex which, when pressed or cured, produce a composite without the need for further shaping or refining. In some embodiments, the prepreg or resin/mat complex material trimmed from the outside of the mold can be recycled by grinding up and adding the trimmings back into the resin.

In other embodiments, the tooling step occurs after the pressing or curing of the composite but before the composite is released from the mold.

### Applications for Environmentally Friendly Composites

As will be appreciated by those skilled in the art, composites comprising provided environmentally friendly compositions are useful in the manufacture of building materials. Building materials composed of provided composites comprising environmentally friendly compositions are fire-retardant as compared to conventional materials such as wood and particle board. In accordance with the present invention, building materials comprised of biocomposites have sufficient nail and screw retention and are suitable alternatives to lumber. Of particular note, building materials comprised of provided composites comprising environmentally friendly compositions are renewable and compostable at the end of their useful life, thereby reducing landfill waste. Further, in some embodiments, provided composites comprising environmentally friendly compositions are produced without the use of formaldehyde or other toxic chemicals, they do not leech or emit formaldehyde into the environment.

In certain embodiments, provided composites comprising environmentally friendly compositions are useful in the manufacture of building materials. In some embodiments, the building materials are a replacement or substitution for lumber. In some embodiments, the building materials have a tensile strength comparable to lumber. In other embodiments, the building materials have a tensile strength greater than lumber. In some embodiments, the building materials are exterior building materials. In certain embodiments, the exterior building materials are water-resistant or water-proof. In other embodiments, the building materials are interior building materials. In still other embodiments, the building materials are structural or support materials.

In certain embodiments, the exterior building materials are siding. In some embodiments, the exterior siding is a shingle. In other embodiments, the exterior siding is a siding panel. In other embodiments, the exterior building materials are panels. In other embodiments, the exterior building materials are boards. In some embodiments, the boards are deck boards. In other embodiments, the exterior building materials are stair boards or risers. In still other embodiments, the exterior building materials are railings. In some embodiments, the exterior building materials are posts such as a lamp post, a mailbox post or a deck post. In some embodiments, the exterior building materials are doors. In other embodiments, the exterior building materials are door or window frames. In some embodiments, the exterior building materials are roofing materials. In certain embodiments, the roofing materials are shingles, shakes or tiles.

In some embodiments, the interior building materials are wall panels such as drywall or wall board. In some embodiments, the wall panels have a dimension of 4′×8′. In other embodiments, the wall panels have a dimension of 4′×12′. In still other embodiments, the wall panels have a dimension of 6′×12′. In some embodiments, the wall panels are corrugated. In other embodiments, the wall panels contain channels to facilitate the running of wires.

In some embodiments, the wall panels contain wires or cables embedded within the panel. In some embodiments, composites of the present invention contain wires or cables which are incorporated into the composite prior to or during the pressing step. In certain embodiments, the wires or cables are selected from the group consisting of speaker wire, low-voltage wire, telephone wire, fiber optic cable and coaxial cable. In some embodiments, the wall panels contain pre-cut peg holes or areas of variable density to accommodate push pins.

In some embodiments, composites of the present invention contain embedded hardware or fittings. In some embodiments, composites of the present invention contain hardware or fittings which are incorporated into the composite prior to or during the pressing step. In some embodiments, the embedded hardware or fittings are selected from threaded inserts, magnets, handles, clasps, hinges, fasteners such as threaded posts, nuts, bolts, standoffs, pins, anchors and sensors. In some embodiments, composites of the present invention contain embedded material such as metals, foil, tubing, glass or plastic. In some embodiments, the embedded metal is either flat or bar stock metal. In some embodiments, the embedded metal is rebar or rods.

In some embodiments, the interior building materials are beams. In some embodiments, the beams have dimensions similar to standard lumber dimensions such as, for example, 2″×4″, 2″×6″ or 1″×6″.

In some embodiments, the interior building materials are planks or boards. In some embodiments, the boards have dimensions similar to standard lumber dimensions such as, for example, 1″×8″, 1″×10″ or 1″×12″.

In certain embodiments, the interior building material is flooring. In some embodiments, the flooring is a subfloor. In other embodiments, the flooring is a laminate. In still other embodiments, the flooring is a veneered board.

In some embodiments, the structural support building materials are I-beams. In other embodiments, the structural support building materials are support beams or studs. In some embodiments, the support beams or studs have dimensions similar to standard lumber dimensions such as, for example, 2″×4″ or 2″×6″.

In some embodiments, composites of the present invention are useful in the manufacture of decorative moldings. In some embodiments, decorative moldings include crown molding, door casing and wainscoting.

In some embodiments, composites of the present invention are useful in the manufacture of interior decking.

In some embodiments, composites of the present invention are useful in the manufacture of cabinetry. In some embodiments, composites of the present invention are useful in the manufacture of doors, such as passageway doors or cabinet doors. In some embodiments, composites of the present invention are useful in the manufacture of shelving units.

### General Process for Preparing Provided Composites

In preparing a resin of the present invention, the first strengthening agent is dissolved in water to form a solution or weak gel, depending on the concentration of the first strengthening agent. The resulting solution or gel is added to the initial protein suspension, with or without a plasticizer, under conditions effective to cause dissolution of all ingredients to produce an aqueous resin comprising an environmentally friendly polymeric composition. The aqueous resin mixture so produced is allowed to impregnate fiber mats, which are then optionally dried to produce prepregs as previously described. The prepregs are optionally stacked to a desired thickness before being subjected to conditions of temperature and/or pressure sufficient to form a composite.

In some embodiments, the resin is optionally dried to a solid form. In some embodiments, the dry solid form is a powder, in the form of flakes, granules, spheroids, and the like. In some embodiments, the resin is optionally dried to a powder. In some embodiments, the resin is spray dried. In other embodiments, the resin is freeze-dried. In still other embodiments, the resin is dried in ambient air. In yet other embodiments, the resin is drum dried.

One of ordinary skill in the art will appreciate that the term “dry” as used herein in connection with a resin or solid form, does not necessarily mean that the resin, or solid form, is anhydrous (i.e., completely devoid of water). Rather, one of ordinary skill in the art will appreciate that a dried resin, or dry solid form, as used herein, can contain an amount of water so as not to interfere with the flowability, stability, and/or processability of the referenced material.

It will be appreciated that other resin ingredients are similarly incorporated into a dried resin composition of the present invention. For example, in some embodiments, the present invention provides a dried resin comprising a protein and first strengthening agent and optionally further comprising a plasticizer, an anti-moisture agent, or an anti-microbial agent, or combination thereof. Such agents can be added to a provided resin composition as an aqueous mixture (i.e., a suspension or solution) or can be combined with the protein and strengthening agent as an admixture (i.e., a physical mixture of dry ingredients).

The dry resin so produced is then optionally combined with a second strengthening agent, consisting of woven or non-woven fibers. The process of impregnation optionally includes a wetting agent, which assures good contact between the dry resin system and the fiber surface. Wetting agents can decrease the duration of impregnation process and result in a more thoroughly impregnated fiber/resin complex. The resin/fiber complex is optionally moistened with a suitable wetting agent, selected from the group comprising propylene glycol, alkylphenol ethoxylates (APEs), Epolene E-43, lauric-acid containing oils such as coconut, Cuphea, Vernonia, and palm kernel oils, ionic and non-ionic surfactants such as sodium dodecylsulfate and polysorbate 80, soy-based emulsifiers such as epoxidized soybean oil and epoxidized fatty acids, soybean oil, linseed oil, castor oil, silane dispersing agents such as Z-6070, polylactic acids such as ethoxylated alcohols UNITHOX™ 480 and UNITHOX™ 750 and acid amide ethoxylates UNICID™, available from Petrolite Corporation, ethoxylated fluorol compounds such as zonyl FSM by Dupont, Inc., ethoxylated alkyl phenols and alkylaryl polyethers, C₁₂-C₂₅ carboxylic acids such as lauric acid, oleic acid, palmitic acid or stearic acid, sorbitan C₁₂-C₂₅ carboxylates such as sorbitan monolaurate, sorbitan monopalmitate, sorbitan monostearate, sorbitan tristearate, sorbitan monooleate or sorbitan trioleate, Gemini surfactants, zinc stearate, high-molecular weight wetting agents such as DISPERBYK-106, DISPERBYK-107 and DISPERBYK-108, available from BYK USA, hyper-branched polymers such as Starfactant™, available from Cognis Corporation, amino acid-glycerol ethers, surfactants such as Consamine CA, ConsamineCW, Consamine DSNT, ConsamineDVS, Consamine JDA, Consamine JNF, Consamine NF, Consamine PA, Consamine X, and Consowet DY, available from Consos, Inc., waxes such as Luwax PE and montan waxes, Busperse 47, available from Buckman Laboratories, non-ionic or anionic wetting agents such as TR041, TR251 and TR255, available from Struktol Company of America, Hydropalat® 120, Igepal CO 630, available from Stepan, Polytergent B-300, available from Harcros Chemical, Triton X-100, available from Union Carbide, alkylated silicone siloxane copolymers such as BYK A-525 and BYK W-980, available from Byk-Chemie, neoalkoxy zirconate and neoalkoxy titanate coupling agents such as Ken React LZ-37, Ken React LZ-97 and LICA 44, available from Kenrich Petrochemicals, Inc., copolyacrylates such as Perenol F-40, available from Henkel Corporation, bis(hexamethylene)triamine, Pave 192, available from Morton International, decyl alcohol ethoxylates such as DeTHOX DA-4 and DeTHOX DA-6, available from DeForest, Inc., sodium dioctyl sulfosuccinate, Igepal CO-430, available from GAF Corp., dispersion aids such as Z-6173, available from Dow Corning Corp, and fatty acids and low molecular weight linear aliphatic polyesters such as polycaprolactone, polyalkanoates and polylactic acid.

Following impregnation, the fiber/resin complex may be optionally cut to desired size and shape. The resin/fiber complex is then formed into a sheet that when cured, either by applying heat or a combination of heat and pressure, will form a layer. To obtain thicker composite sheets, a plurality of sheets can be stacked for curing. The sheets can be stacked with unidirectional fibers and yarns at different angles in different layers.

In some embodiments, the dry resin is reconstituted with water prior to impregnating a fiber or fabric. In other embodiments, the dry resin is applied directly to a dry fiber or fabric. In still other embodiments, the dry resin is applied to dry fiber or fabric and a minimal amount of water is added to facilitate the curing step.

### Corrugated Panels

Corrugated panels consist of two parallel surfaces with a zig-zag web of material linking them. The process for creating these panels forms the material around a set of trapezoidal fingers. Specifically, one prepreg layer is placed on a flat, heated platen. A set of parallel trapezoidal fingers is placed on top of the first prepreg. Another prepreg is set on top of the first set of fingers. The second set of fingers are then placed on top of the previous prepreg. This second set of fingers alternates with the bottom set, allowing the prepreg in between the fingers to form the zig-zag web connecting the outer prepregs. A final prepreg is placed on top of the second set of fingers. Finally, the top heated platen is placed on top of the uppermost prepreg. This layup is subjected to temperature and pressure as defined above. During pressing, the tops of the first set of fingers align with the bottoms of the second set, and vice versa. Once the part has cured, the fingers are pulled out from the side (normal to the edge of the final part) and the part is complete.

Composites with Varying Densities

Subjecting different areas of a part to higher or lower pressures during curing creates variable density parts. This difference in pressure can be accomplished several ways. The first method involves varying the distance between tooling elements while keeping the prepreg material thickness constant. Less distance between tooling elements translates into higher densities and thinner cross sections in the finished part. The second method for creating variable densities involves varying the amount of prepreg material that is placed in the tooling mold. If the material is doubled in one area of the mold, for a constant distance between tooling elements, the finished part will have twice the density where the additional material was placed. These two methods of varying the density can be combined to create variations in both density and thickness.

In addition to varying the thickness, the tooling elements can be used to make cutouts or holes in the finished part. These features are created by simply closing the distance between tooling elements to zero as the two halves of the mold are brought together.

### Exemplification

A resin comprising an environmentally friendly polymeric composition in accordance with the present invention may be prepared by the following illustrative procedures.

### EXAMPLE 1

The agar mixture was prepared in a separate container by mixing an appropriate amount of agar with an appropriate amount of water at or below room temperature.

A 50 L mixing kettle was charged with 25 L water and heated to about 50° C. to about 85° C. Half of the appropriate amount of protein was added and the pH of the mixture of adjusted to about 7-14 with a suitable base, for example a 1N sodium hydroxide solution. To the resulting mixture were added Teflex® and sorbitol, followed by the preformed agar mixture. The remainder of the protein was then added and a sufficient volume of water added to the mixture to bring the total volume to about 55 L. The mixture was allowed to stir at about 70° C. to about 90° C. for 30-60 minutes. The beeswax was then added and the resin mixture was allowed to stir at about 70° C. to about 90° C. for about 10-30 minutes.

The resin solution so produced was applied to a fiber structure such as a mat or sheet in an amount so as to thoroughly impregnate the structure and coat its surfaces. The fiber mat was subjected to the resin in the impregger for about 5 minutes, before being loosely rolled and allowed to stand for about 0-5 hours. The resin-impregnated mat was then optionally resubjected to the resin by additional passes through the impregger, before being loosely rolled and optionally allowed to stand for about 0-5 hours. In some embodiments, the prepreg is processed without a standing or resting step, for example in a high-throughput process utilizing continuously moving machinery such as a conveyor belt.

The fiber structure so treated was pre-cured by drying, for example, in an oven, at a temperature of about 35-70° C. to form what is referred to as a prepreg. In some embodiments, the impregnated fiber structure is pre-cured at temperatures up to 300° C. In another embodiment, the prepreg is dried using steam heat. In yet another embodiment, the prepreg is dried using microwave technology. In yet another embodiment, the prepreg is dried using infrared technology. Alternatively, the structure is dried on one or more drying racks at room temperature or at outdoor temperature.

Once dry, the resin-impregnated mats were conditioned or equilibrated to a uniform dryness. In some embodiments, the mats were conditioned for about 0-7 days. Once conditioned, the prepreg has a moisture content of between 2 and 40 percent. In some embodiments, the moisture content of the dried prepreg is between about 5 and 15 percent. In other embodiments, the moisture content of the dried prepreg is between about 5 and 10 percent.

The layered prepregs and optional decorative coverings were pressed at a temperature of about 110° C. to about 140° C. and pressure of about 0.001-200 tons per square foot. The strength and density of the resulting composites are proportional to the pressure applied to the prepregs. Thus, when a low density composite is required, little to no pressure is applied.

### EXAMPLE 2

The agar mixture was prepared in a separate container by mixing an appropriate amount of agar with an appropriate amount of water at or below room temperature.

A 50L mixing kettle was charged with 25 L water and heated to about 50° C. to about 85° C. Half of the appropriate amount of protein was added and the pH of the mixture of adjusted to about 7-14 with a suitable base, for example a 1N sodium hydroxide solution. To the resulting mixture were added Teflex® and sorbitol, followed by the preformed agar mixture. The remainder of the protein was then added and a sufficient volume of water added to the mixture to bring the total volume to about 55L. The mixture was allowed to stir at about 70° C. to about 90° C. for 30-60 minutes. The beeswax was then added and the resin mixture was allowed to stir at about 70° C. to about 90° C. for about 10-30 minutes.

The prepared resin was then subject to drying by spray drying or, alternatively, drum drying.

The dry resin was reconstituted using nine parts of water and one part dry resin. The mixture was heated to 90° C. and stirred until mostly dissolved.

The reconstituted spray dried resin so produced was used to impregnate six layers of non-woven fiber. Enough reconstituted resin was added to bring the ratio of resin solids to dry fiber to 50:50. The non-woven fiber mats were impregnated with the resin for about 5 minutes, before being loosely rolled and allowed to stand for about 0-5 hours. The resin-impregnated mat was then optionally resubjected to the resin by additional passes through the impregger, before being loosely rolled and optionally allowed to stand for about 0-5 hours. In some embodiments, the prepreg is processed without a standing or resting step, for example in a high-throughput process utilizing continuously moving machinery such as a conveyor belt. The prepregs were dried overnight to a moisture content of 6-9%. The stack of six preregs was pressed for 13 minutes under the typical conditions of 50 tons per square foot and 125° C.

### EXAMPLE 3

The agar mixture was prepared in a separate container by mixing an appropriate amount of agar with an appropriate amount of water at or below room temperature.

A 50L mixing kettle was charged with 25L water and heated to about 50° C. to about 85° C. Half of the appropriate amount of protein was added and the pH of the mixture of adjusted to about 7-14 with a suitable base, for example a 1N sodium hydroxide solution. To the resulting mixture were added Teflex® and sorbitol, followed by the preformed agar mixture. The remainder of the protein was then added and a sufficient volume of water added to the mixture to bring the total volume to about 55L. The mixture was allowed to stir at about 70° C. to about 90° C. for 30-60 minutes. The beeswax was then added and the resin mixture was allowed to stir at about 70° C. to about 90° C. for about 10-30 minutes.

The prepared resin was then subject to drying by spray drying or, alternatively, drum drying. The dried resin was applied directly to damp fiber and then pressed for 13 minutes under the typical conditions of 50 tons per square foot and 125° C.

We claim:

1. A building material comprising a naturally-sourced composite, wherein the building material is selected from exterior building material, interior building material and structural building material.

2. The building material of claim 1, wherein the naturally-sourced composite comprises a biodegradable polymeric composition and a fiber-based strengthening agent.

3. The building material of claim 2, wherein the naturally-sourced composite comprises a biodegradable polymeric composition comprising a protein, a first strengthening agent, and optionally a plasticizer, an antimoisture agent and/or an antimicrobial agent.

4. The building material of claim 3, wherein the naturally-sourced composite comprises a biodegradable polymeric composition comprising a protein selected from soy, canola, sunflower, rye, wheat, corn, collagen, gelatin, casein, albumin, silk, elastin, and combinations thereof.

5. The building material of claim 3, wherein the naturally-sourced composite comprises a biodegradable polymeric composition comprising a first strengthening agent selected from gelatin, carageenan, other suitable protein gels, agar, gellan, agaropectin, agarose, alginic acid, ammonium alginate, annacardium occidentale gum, calcium alginate, carboxyl methyl-cellulose (CMC), carubin, chitosan acetate, chitosan lactate, E407a processed eucheuma seaweed, gelrite, guar gum, guaran, hydroxypropyl methylcellulose (HPMC), isabgol, locust bean gum, pectin, pluronic polyol F127, polyoses, potassium alginate, pullulan, sodium alginate, sodium carmellose, tragacanth, xanthan gum, caproic acids, caproic esters, castor bean oil, fish oil, lactic acids, lactic esters, poly L-lactic acid (PLLA), polyols, montmorillonite, fluorohectorite, laponite, bentonite, beidellite, hectorite, saponite, nontronite, sauconite, vermiculite, ledikite, nagadiite, kenyaite, stevensite, microfibrillated cellulose, a nanofibrillated cellulose, carbodiimides, hydroxysuccinamide esters, hydrazides, aldehydes or dialdehydes, polyphosphates, polyethylene or polypropylene emulsions, ethylene-acrylic acid copolymers, and combinations thereof.

6. The building material of claim 3, wherein the naturally-sourced composite comprises a biodegradable polymeric composition further comprising a plasticizer selected from glycerol, sorbitol, propylene glycol, diethylene glycol, polypropylene glycols in the molecular weight range of 200-400 amu or polyphosphates, diisononyl phthalate (DINP), diisodecyl phthalate (DIDP), acetylated monoglycerides alkyl citrates, triethyl citrate (TEC), acetyl triethyl citrate (ATEC), tributyl citrate (TBC), acetyl tributyl citrate (ATBC), trioctyl citrate (TOC), acetyl trioctyl citrate (ATOC), trihexyl citrate (THC), acetyl trihexyl citrate (ATHC), butyryl trihexyl citrate (BTHC), trimethyl citrate (TMC), alkyl sulfonic acid phenyl ester (ASE), lignosulfonates, beeswax, oils, sugars, polyols, low molecular weight polysaccharides, and combinations thereof.

7. The building material of claim 3, wherein the naturally-sourced composite comprises a biodegradable polymeric composition further comprising an antimoisture agent selected from paraffin wax, paraffin oil, mineral oil, beeswax, whale oil, carnauba wax, tea tree oil, soy wax, soy oil, lanolin, palm oil, palm wax, peanut oil, sunflower oil, rapeseed oil, canola oil, algae oil, coconut oil, carnauba oil, lignin, stearic acid, stearate salt, or stearate ester, carbodiimides, hydroxysuccinamide esters, hydrazides, aldehydes or dialdehydes, polyphosphates, polyethylene or polypropylene emulsions and ethylene-acrylic acid copolymers.

8. The building material of claim 3, wherein the naturally-sourced composite comprises a biodegradable polymeric composition further comprising an antimicrobial agent selected from Teflex®, boric acid or a salt thereof, Microban™, pyrithione salts, parabens, paraben salts, quaternary ammonium salts, allylamines, echinocandins, polyene antimycotics, azoles, isothiazolinones, imidazolium, sodium silicates, sodium carbonate, sodium bicarbonate, potassium iodide, silver, copper, or sulfur, sulfite salts, bisulfite salts, metabisulfite salts, benzoic acid, benzoate salts, or an essential oil comprising tea tree oil, sideritis, oregano oil, mint oil, sandalwood oil, clove oil, nigella sativa oil, onion oil, leleshwa oil, lavendar oil, lemon oil, eucalyptus oil, peppermint oil, cinnamon oil, thyme oil, grapefruit seed extract, lemon myrtle, olive leaf extract, patchouli, citronella oil, orange oil, pau d'arco or neem oil, or combinations thereof.

9. The building material of claim 2, wherein the naturally-sourced composite comprises a fiber-based strengthening agent selected from kenaf, hemp, flax, wool, silk, cotton, ramie, sorghum, raffia, sisal, burlap, jute, sugar cane bagasse, coconut, pineapple, abaca (banana), sunflower stalk, sunflower hull, peanut hull, wheat straw, oat straw, hula grass, henequin, corn stover, bamboo, saw dust, recycled fiber from clothing and paper products, manure, viscose rayon, lyocell, hair, fur, silk, feathers, spider silk and wool, burlap, linen, flax, wool, cotton, hemp, silk, rayon and combinations thereof.

10. The building material of claim 3, wherein the exterior building material is selected from a roofing element, a siding element, a panel, a board, a post, a door, a door frame or a window frame.

11. The building material of claim 10, wherein the siding element is a shingle or panel.

12. The building material of claim 10, wherein the board is selected from a deck board, a stair board, a riser or a railing.

13. The building material of claim 10, wherein the post is selected from a lamp post, a mailbox post or a deck post.

14. The building material of claim 10, wherein the roofing element is selected from shingles, shakes or tiles.

15. The building material of claim 3, wherein the interior building material is selected from a wall panel, a flooring element, a board, a beam, a decorative molding, shelving, cabinets and cabinet doors.

16. The building material of claim 15, wherein the wall panel is drywall or wall board.

17. The building material of claim 16, wherein the wall panel has a dimension of 4′×8′, 4′×12′ or 5′×12′.

18. The building material of claim 16, wherein the wall panel is corrugated.

19. The building material of claim 16, wherein the wall panel contains channels.

20. The building material of claim 16, wherein the wall panel contains embedded wires or cables.

21. The building material of claim 20, wherein the wires or cables are speaker wire, low-voltage wire, telephone wire, fiber optic cable or coaxial cable.

22. The building material of claim 15, wherein the flooring element is a subfloor, a laminate or a veneered board.

23. The building material of claim 15, wherein the decorative molding is selected from crown molding, door casing and wainscoting.

24. The building material of claim 3, wherein the structural building material is selected from an I-beam, support beam or stud.

25. The building material of claim 3, wherein the naturally-sourced composite is decorated.

26. The building material of claim 25, wherein the naturally-sourced composite is colored.

27. The building material of claim 26, wherein the composite comprises a colored fiber.

28. The building material of claim 26, wherein the composite comprises a colored biodegradable polymeric composition.

29. The building material of claim 25, wherein an outer layer of the naturally-sourced composite is selected from a wood veneer ply, a colored fabric, a fabric containing a design or a silkscreened fabric.

30. The building material of claim 3, wherein the naturally-sourced composite contains one or more embedded hardware elements.

31. The building material of claim 30, wherein the embedded hardware elements are selected from threaded inserts, magnets, handles, clasps, hinges, fasteners such as threaded posts, nuts, bolts, standoffs, pins, anchors and sensors.
